(19) United States
(12) Patent Application Publication
(10) Pub. No.: US 2014/0145961 A1
(43) Pub. Date: May 29, 2014

(54) COMPUTER KEYBOARD, SOFTWARE, AND GLOVES FOR LEARNING TOUCH-TYPING

(71) Applicant: Telefirma, Inc., Brooklyn, NY (US)

(72) Inventor: Istvan Szent-Miklosy, New York City, NY (US)

(73) Assignee: Telefirma, Inc., Brooklyn, NY (US)

(21) Appl. No.: 14/090,696

(22) Filed: Nov. 26, 2013

Related U.S. Application Data
(60) Provisional application No. 61/730,327, filed on Nov. 27, 2012.

(51) Int. Cl. G06F 3/02

(52) U.S. Cl. CPC G06F 3/02
USPC 345/168

(57) ABSTRACT

A method comprises providing a keyboard including a plurality of keys each encoded with a color and enabled to be individually illuminated, providing a first glove and a second glove each glove including a plurality of fingers wherein each of the plurality of fingers comprise a finger color, displaying a text to be typed via the keyboard and illuminating one of the plurality of keys corresponding to a next letter in the text to be typed wherein the encoded color of the illuminated key corresponds to a color of a finger of one of the first glove and the second glove for engaging the illuminated key.

### CROSS-REFERENCE TO RELATED APPLICATIONS

This application claims the benefit of priority to U.S. Provisional Patent Application No. 61/730,327 filed Nov. 27, 2012 titled “COMPUTER KEYBOARD, SOFTWARE, AND GLOVES FOR LEARNING TOUCH-TYPING”.

### BACKGROUND

1. Field

This disclosure relates, generally, to methods for learning to touch type and apparatus for practicing same.

2. Description of Related Art

Would-be touch typists who are new to using a keyboard, knowing neither the positions of the various keys, nor the correct finger to use to press each key, and who also have not yet developed the fine-motor skill with which to make the movements required for keys that need the fingers to be extended from their resting positions, for example Q, and Z, face an array of challenges in acquiring the skill of keyboarding. The complexity of this skill is sufficient that it typically takes a young person two to three years of training and practice before reaching a reasonable level of accuracy and speed.

Conventional wisdom and practice hold that a typing learner should at all costs not look at the keys on the keyboard, but rather only at the text to be typed, be it on screen or paper. This notion has been carried so far by some as to actually hide the student's hands under cardboard boxes, to enforce compliance with the idea of not looking at the keys. Yet other methods discourage looking at the keys by concealing the letters from the keys' faces. Such methodologies serve to hamper and otherwise inhibit the initial acquisition of typing by learners. What is therefore needed is an apparatus and a method for using same that increases the speed and ease with which a learner can learn to type.

### SUMMARY

In accordance with an exemplary and non-limiting embodiment, a method comprises providing a keyboard comprising a plurality of keys each encoded with a color and enabled to be individually indicated, providing a first glove and a second glove each glove comprising a plurality of fingers wherein each of the plurality of fingers comprise a finger color, displaying a text to be typed via the keyboard and indicating one of the plurality of keys corresponding to a next letter in the text to be typed wherein the encoded color of the indicated key corresponds to a color of a finger of one of the first glove and the second glove for engaging the indicated key.

In accordance with another exemplary and non-limiting embodiment, a method comprises displaying a virtual keyboard corresponding to a keyboard and comprising a plurality of keys each encoded with a color and enabled to be individually illuminated, providing a first glove and a second glove each glove comprising a plurality of fingers wherein each of the plurality of fingers comprise a finger color, displaying a text to be typed on the keyboard and illuminating one of the plurality of keys of the virtual keyboard corresponding to a next letter in the text to be typed wherein the encoded color of the illuminated key corresponds to a color of a finger of one of the first glove and the second glove for engaging the illuminated key on the keyboard.

In accordance with anther exemplary and non-limiting embodiment, a computer readable medium contains program instructions wherein execution of the program instructions by one or more processors of a computer system causes the one or more processors to carry out the steps of displaying a virtual keyboard corresponding to a keyboard and comprising a plurality of keys each encoded with a color and enabled to be individually illuminated, displaying a text to be typed on the keyboard and illuminating one of the plurality of keys of the virtual keyboard corresponding to a next letter in the text to be typed wherein the encoded color of the illuminated key corresponds to a color of a finger of a first glove and a second glove for engaging the illuminated key on the keyboard.

### BRIEF DESCRIPTION OF FIGURES

FIG. 1 is an illustration of a keyboard in accordance with an exemplary and non-limiting embodiment.

FIG. 2 is an illustration of a pair of gloves in accordance with an exemplary and non-limiting embodiment.

FIG. 3 is an illustration of an alternative glove configuration in accordance with an exemplary and non-limiting embodiment.

FIG. 4 is an illustration of a virtual keyboard in accordance with an exemplary and non-limiting embodiment.

FIG. 5 is an illustration of a letterless mode of operation in accordance with an exemplary and non-limiting embodiment.

FIG. 6 is an illustration of a hardware configuration in accordance with an exemplary and non-limiting embodiment.

FIG. 7 is a flowchart of a method in accordance with an exemplary and non-limiting embodiment.

FIG. 8 is an illustration of a keyboard skin in accordance with an exemplary and non-limiting embodiment.

FIG. 9 is an illustration of finger superimposition on a virtual keyboard in accordance with an exemplary and non-limiting embodiment.

FIG. 10 is an illustration of a computer screen in accordance with an exemplary and non-limiting embodiment.

FIG. 11 is a flowchart of a method in accordance with an exemplary and non-limiting embodiment.

### DETAILED DESCRIPTION

In accordance with exemplary and non-limiting embodiments, the method disclosed herein encourages looking at the keys in the earliest stage of learning keyboarding. As described below, using bright and attractive colors and individually lighting keys draws attention to the keys. Exemplary embodiments acknowledge that in the earliest phase of learning one in fact has to look at the keys as one is trying to become familiar with the locations of each letter and its key. In accordance with exemplary and non-limiting embodiments, learners obtain early motor proficiency before being required to focus on the more working memory-intensive task of visually decoding the letter of each key and only then beginning the motor performance of pressing the given key. Following a path of illuminating lights permits learners to focus their early energy on the finger movements, liberated from the need to hunt, and the resulting herky-jerky performance borne of constantly shifting attention between hunting and pressing. Approaching the task of learning in this sequence also has the benefit of giving the learner significant familiarization of the key locations from this early practice so that when they embark on the next phase of solidifying their knowledge of the locations of the keys, they are not starting from scratch.

In accordance with an exemplary and non-limiting embodiment, a method and apparatus for learning keyboarding is disclosed in which a computer keyboard has keys that light up individually. A pair of gloves having colored fingers, the colors of the fingers corresponding to colored keys of the keyboard wherein the next key to press is strongly signaled by both the bright illumination of the particular key's light emitting diode (LED), and by an associated large colored circle on the virtual keyboard depicted on the learner's computer screen.

In accordance with another exemplary and non-limiting embodiment as might be employed at a later stage in the learning process, development of speed in motor performance is aided by showing and illuminating not of a single key to press, but rather the next two keys to press, the current key being strongly indicated, and the subsequent key being less strongly indicated.

As disclosed herein in exemplary fashion, the learning method differs from existing approaches by encouraging typing learners to look at the keys during the first and hardest stage in learning. The unfolding sequence of lighting keys provides learners with a sense of immediate success by giving them easy practice in performing fine motor movements. The method eliminates hunting for each key, focusing the initial learning activity instead on becoming familiar with the complex finger movements. Finding the location of each unfamiliar key amongst the large array of possibilities is normally a slow, frustrating, and working memory-intensive task. In accordance with the disclosed embodiments, finding the location of unfamiliar keys instead becomes a passive activity as the next key is clearly identified by being lit up. This enables learners to establish a foundation of motor proficiency before later turning to the task of internalizing the locations of each key.

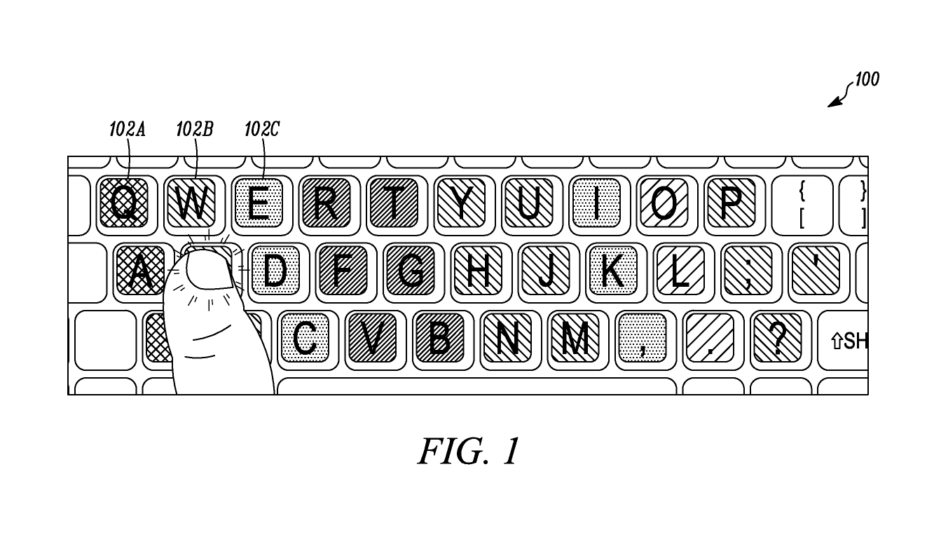

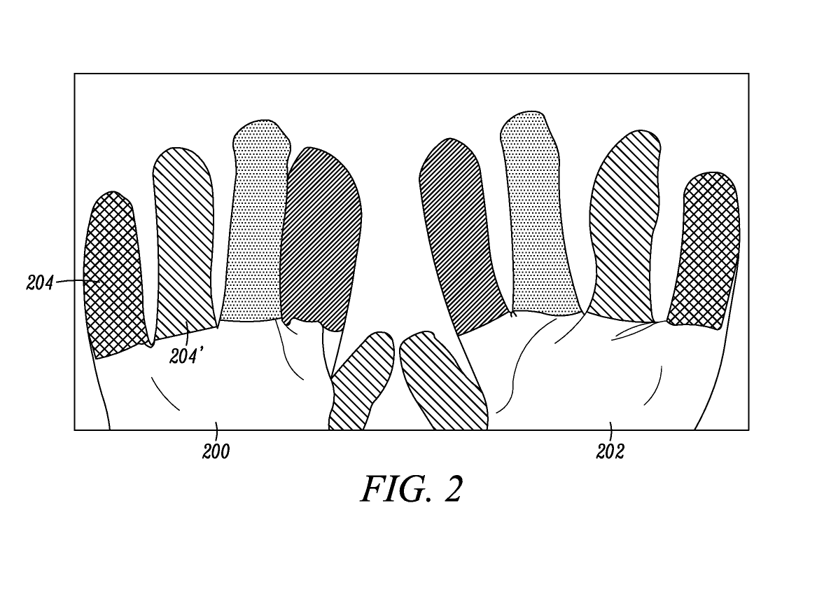

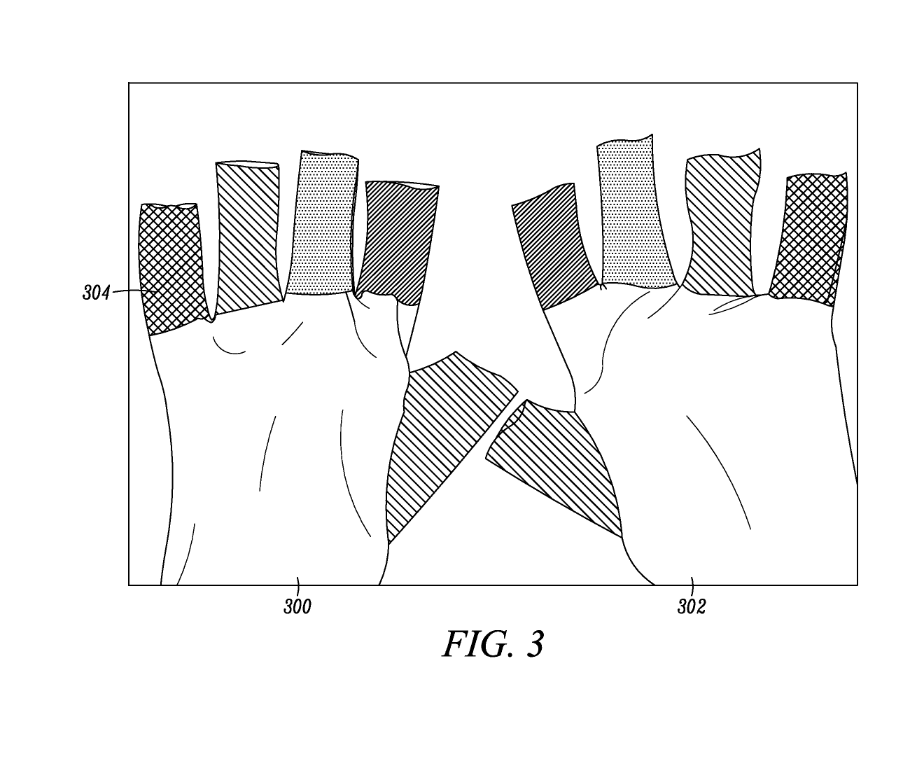

With reference to FIG. 1A, there is illustrated a physical keyboard 100 with individually lighting keys 102(A), 102(B) . . . 102(X) according to an exemplary embodiment. As illustrated, the areas surrounding each letter of each key 102 are colored to indicate which finger of which hand is the proper finger for engaging the key for the letter. For example, the areas of the keys 102 surrounding the letters “W”, “S” and “X” may be colored, for example, red. With reference to FIG. 2 there are illustrated two gloves, a left 200 and a right glove 202 , wherein each of the fingers 204 is colored. Note that the left ring finger 204′ is shaded to correspond to the color/shading of the letters “W”, “S” and “X” of FIG. 1. With reference to FIG. 3, there is illustrated an alternative exemplary embodiment of gloves 300, 302 wherein each finger 304 does not extend the full length of a user's finger. Rather, each finger 304 is truncated so as not to diminish a user's sense of touch when manipulating the keyboard keys 102. Note that, with reference to FIGS. 1-3, color is indicated in black and white via selective and differential shading of keys and glove fingers. For purposes of more clearly illustrating attributes of exemplary embodiments that do not wholly depend on such color, later figures are illustrated without such shading. In such instances, it is understood that the color scheme described elsewhere herein may be employed as well.

In accordance with an exemplary and non-limiting embodiment, the text the user/typist is to practice typing is displayed on a computer screen. Corresponding to the next character to type as indicated on screen, a key on the keyboard is illuminated. By associating individually colored fingers with keys of matching colors, the typist can clearly see which finger to use for the currently lighted key.

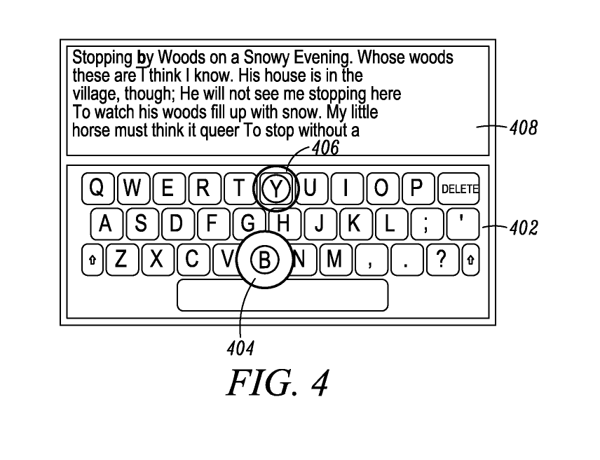

With reference to FIG. 4, in accordance with another exemplary embodiment, a virtual keyboard 402 is provided, along with one or two large circles 404, 406 which indicate the next one or two keys to press as the typist types the lesson text 408 displayed on their computer screen. As the typist gradually gains skill at encoding the locations of the various keys, and as the need to look down at the keyboard lessens, it is nonetheless useful to have an on-screen indication of the next letter to press. This is a less direct method than the lighting keys, but can serve as a useful scaffold as the typist gradually better internalizes the key locations. The on-screen indication shows an accurate spatial layout of the keys on the virtual keyboard 402, and can help orient the typist to the location of the next key to press without having to look down at the keyboard 100.

Use of a large circle 404 to indicate the key to press has additional advantages. The large colorful circles 404 are also attractive in their own right, and the fact that they move around as the keys are pressed gives the typist two engaging elements to see and to follow, giving the experience a pleasurable, almost game-like quality. In accordance with various exemplary embodiments, the transitions between the provision of visual indicia may vary. For example, after an indicated key is pressed, circle 404 may shrink or may fade. Doing so encourages further practice, which is the most critical factor in successfully acquiring typing proficiency. Acquiring the skill of typing requires extended repetition and practice. Existing methods tend to become tedious to many learners. The combination of moving circles 404, 406 and keypress sounds provide stimulus to eliminate tedium.

Perceiving a visual indicia of the next key to press that is of a similar spatial area and/or dimension as that of other not indicated keys requires a fairly fine visual recognition and discernment on the part of the learner. Conversely, employing a relatively large visual or graphic indicator qualitatively changes the visual processing cost of identifying the key to be pressed. For example, in accordance with exemplary embodiments, circles 404, 406, as well as other visual indicia, may be on the order of twice as large or larger than the representation of the key with which they are associated.

A keyboarding learner has to juggle multiple concurrent working memory and fine motor tasks when practicing touch typing. Such tasks include, but are not limited to, storing the current word to be typed in short term memory, isolating the individual letter within the word that needs to be typed now, recalling where on the keyboard that letter is located, distinguishing which finger to use to press the key, commencing the fine motor movement of wrist and finger to perform that keypress, etc. As a result, touch typing is a challenge initially and takes months and years of practice in order to perform efficiently and quickly. Gross/unusually large visual indications of the current key to press changes the cost of the spatial pinpointing task, thereby freeing up additional mental resources for the other concurrent tasks. A large indicator jumps out visually, thereby demanding much less close visual attention on the part of the learner.

Such large indicia can be perceived more through peripheral visual processing as a learner can place more visual focus on the lesson text and its words than on the virtually represented keyboard. The gross visual stimulus cues the rough region of the keyboard wherein which the indicated key is located, and, thus, the appropriate wrist movement can commence in response to the stimulus before the specific finger is chosen to perform the keypress. In essence, the performance of the individual keypress becomes more of a motor task that a visual one, thanks to the cuing by the very large graphic indicator.

As noted above, not one but two indicating circles 404, 406 may be displayed on screen 400. Typing for the beginner typically requires one to three seconds in order to perform each keypress. Whereas a skilled touch-typist performs five or more keypresses per second. As proficiency increases, typing becomes more and more a matter of developing coordinated motor performance of sequences of keys, not the isolated individual keypresses of the beginner. Showing not one but two circles 404, 406, and therefore the next two keys to press, serves to cue performance of a coming keypress while the current keypress is being performed.

In accordance with another exemplary embodiment, the learning experience over time is separated into distinct phases, corresponding to the evolving needs of the typist as skill is gradually gained over months of practice. In the first phase, emphasis is placed on simply performing the fine-motor finger movements associated with keypresses. The lighting keys simplify the task at this stage, as the typist does not need to hunt for keys, but simply to follow the progressing path of lighting keys.

Then, during the next phase, once the typist has acquired some dexterity at the often awkward finger movements, the emphasis is shifted to better encoding the locations of all the keys. During this phase, the typist's attention starts to shift away from the lighting keys 102, and toward the computer screen 400, following either the displayed characters 408 to type, or gazing a few inches down to see the cuing provided by the large circle 404. This entails much less of a disruption to performance than the many-inch glance that shifting one's gaze all the way down to the keyboard requires. In still later phases of learning, additional on-screen features serve to facilitate further encoding and speed proficiency.

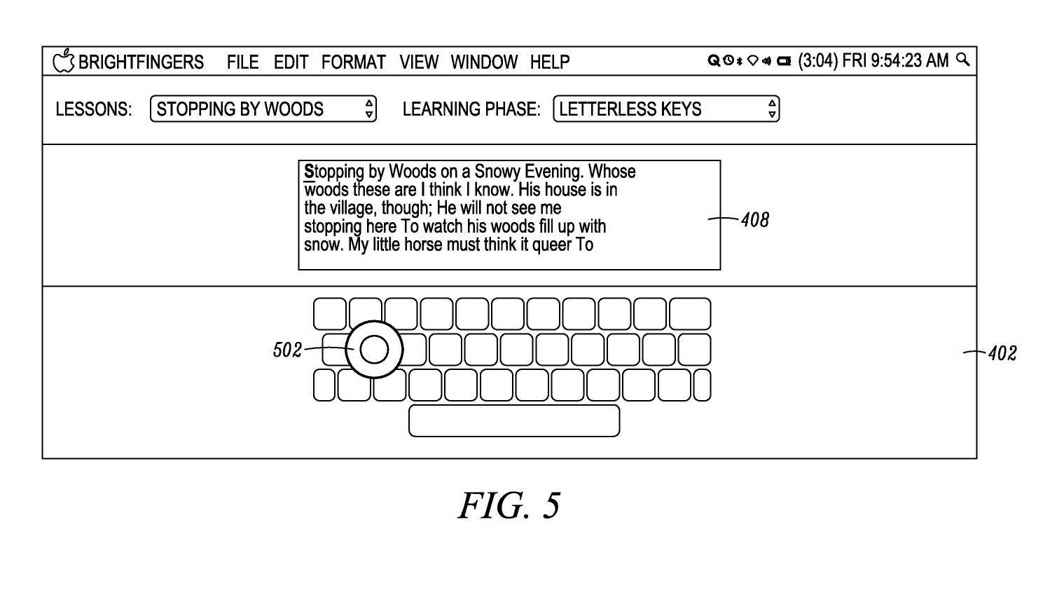

In accordance with one exemplary embodiment, software may be set up to display a second circle 406, to show not only the current key to type but also to cue the performance of the upcoming keypress in parallel. With reference to FIG. 5, there is illustrated a further exemplary and non-limiting embodiment wherein the on-screen keys may be set to be letterless. In this mode, the circles 502 still show the location on the visual keyboard of the next key(s) to press, but the lettering is hidden, in order to enhance the spatial encoding without relying on consciously associating a letter to a key but rather training the motor learning of the fingers. In this way the activity eventually becomes automatically performed, without having the conscious working memory step of visually decoding the letter on each key.

In accordance with exemplary and non-limiting embodiments, a variety of visual fading techniques may be used to help typists transition from one learning phase to another. As used herein. “fading” refers to the diminution of a perceivable visual cue, such as key lighting, key coloring, circles, etc., over time. Whereas in the earliest stage of learning, the method disclosed herein encourages looking at the keys, by way of lighting up the next key to press, eventually the typist wants to be able to type without looking at the keys, relying instead on acquired motor learning. A mode is therefore provided in which, over the course of a given lesson, the lighting of the individual keys is gradually reduced from full brightness to no illumination. Similarly, the visibility of the letters, and of the circles, can also be set to fade over the course of a lesson. In this way the typists attention is gradually encouraged to shift away from looking at one learning aid, such as lighted keys, indicating circles, or virtual key letters, so that the focus can be turned to the next stage in learning. In the case of the gradually disappearing circles, for example, this would mean that visual attention is shifted to just looking at the series of words to type, and not at the spatial cuing provided by the on-screen circles.

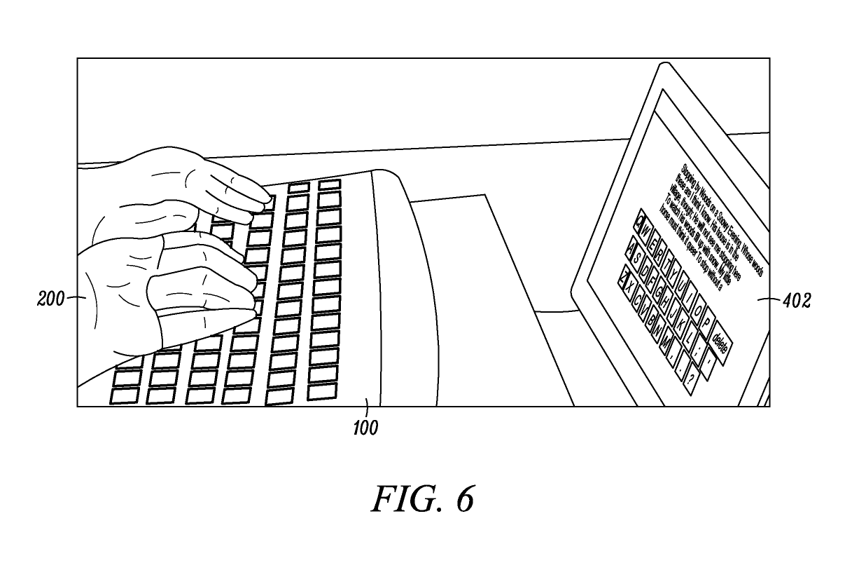

With reference to FIG. 6, there is illustrated an exemplary and non-limiting embodiment of the interaction of gloves 300, keyboard 100 and virtual keyboard 402.

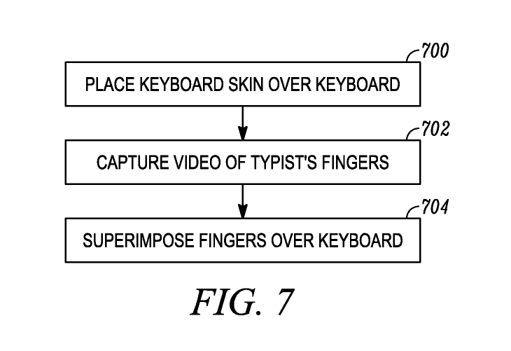

With reference to FIG. 7, there is illustrated a flowchart of a method according to an exemplary and non-limiting embodiment. At step 700, as described more fully below, a keyboard skin may be placed over the physical keyboard's keys to enable the isolation of the typist's fingers for display over the virtual keyboard. At step 702, a video feed of a typist's fingers is captured such as by, for example, a video camera. At step 704, a real-time or near real-time video feed of the typist's fingers is semi-translucently superimposed over the on-screen virtual keyboard.

When a typist is still at the early stage of learning, and is looking at the keys in order to type, gaze must be shifted many inches from keyboard to screen and back. This is a significant interruption to the fluidity of performance and practice. Furthermore, in spite of the lighting keys, and the large circles, that show generally where the next to type is on the keyboard, the fingers still occlude the letters on the keys when looking at the physical keyboard.

In accordance with the present embodiment, the typist can remain focused on the screen at all times, as the fingers are still visible while looking at the screen. Moreover, the letter of each key can nonetheless still be seen, as the video feed of the fingers is semi-translucent, allowing the letters of the virtual keyboard to be seen through the superimposed fingers. Being able to watch the fingers in real-time further helps in learning to perform the often awkward fine motor movements, as the visual input helps the typist properly guide the fingers to reach, for example, the sharply offset bottom-row keys. In order to achieve this effect, as noted above, chroma keying is used to separate the fingers from the background of the keys. For example, a black keyboard skin may be placed over the physical keyboard's keys, so that black is used as the chroma key color, enabling only the fingers to be viewed on screen.

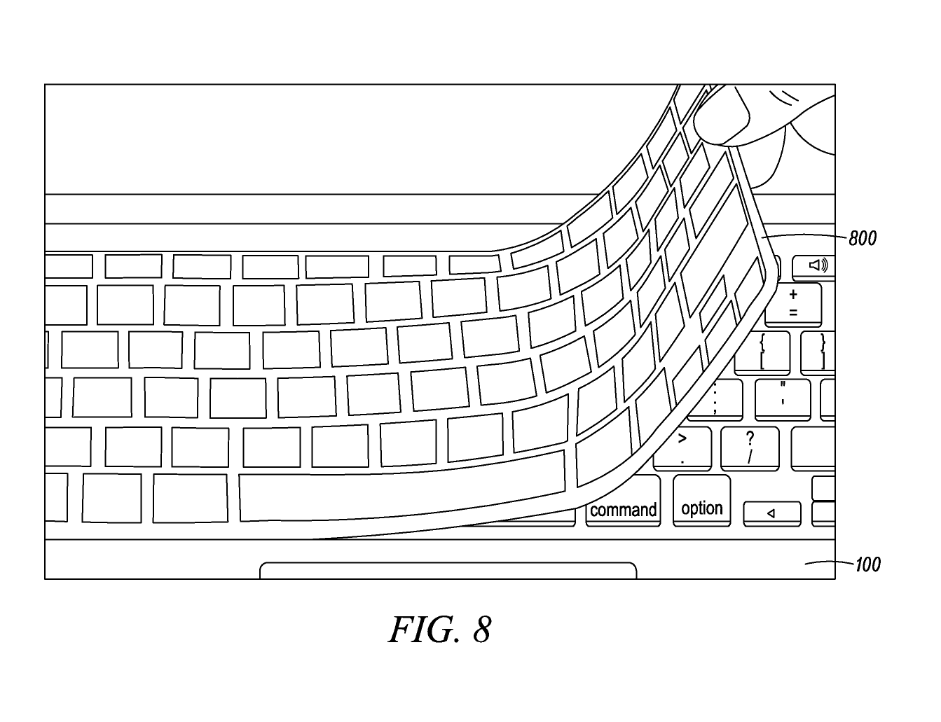

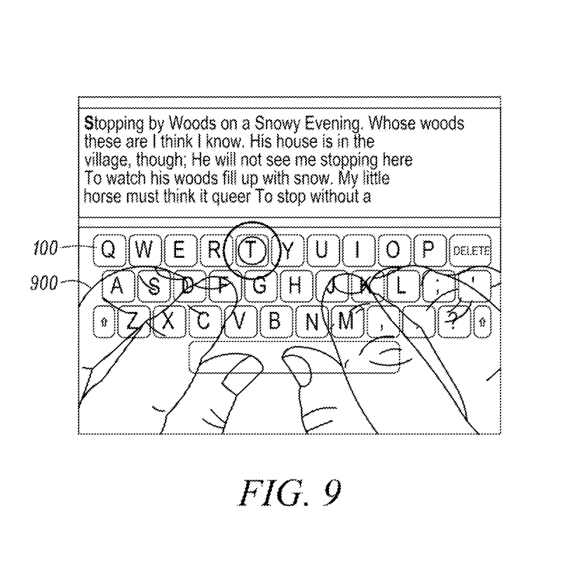

With reference to FIG. 8, there is illustrated a user applying a keyboard skin 800 to a keyboard 100. The video feed of the fingers and keyboard, as for example provided by a webcam pointed down at the hands and keys, may be chroma key processed in real-time, so that only the part of the image showing the fingers, and not the physical keys, is then superimposed over the virtual keyboard depicted on screen. With reference to FIG. 9, there is illustrated an exemplary embodiment of a user's fingers 900 superimposed over virtual keyboard 402. As illustrated, fingers 900 are rendered in translucent fashion so as to permit viewing of virtual keyboard 402 through the rendering of fingers 900.

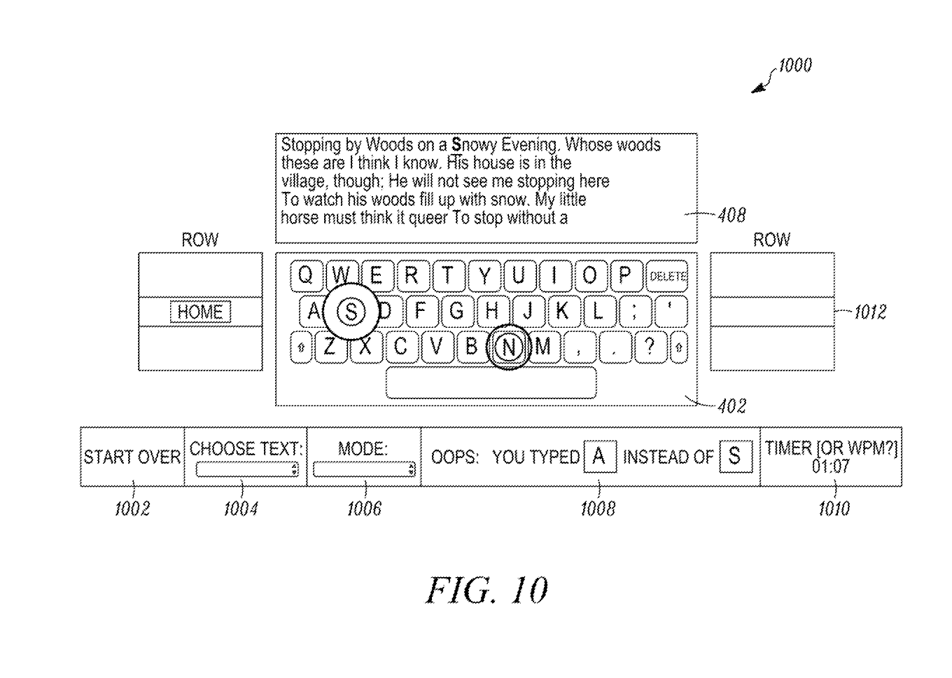

With reference to FIG. 10, there is illustrated an exemplary and non-limiting embodiment of a computer screen 1000. As illustrated, computer screen 1000 comprises lesson text 408 and virtual keyboard 402. In addition, a plurality of other controls may be provided to configure the operation of software affecting the functionality described above. For example, start over button 1002 may be selected by the user to reset or otherwise recommence a typing lesson. Choose text control 1004 may be used to select one of many text selections for display as lesson text 408. Mode control 1006 may be used to select one of many operational modes including, but not limited to, one circle mode, two circle mode and letterless mode. Correction control 1008 may indicate to a user when an incorrect letter is typed by a user. Timer 1010 may be set to a user selectable period of time during which, for example, the user wishes to have computed and displayed the user's words per minute (WPM) typed. Finger indicator 1012 may serve to indicate which row and which hand is to be used to engage an indicated letter.

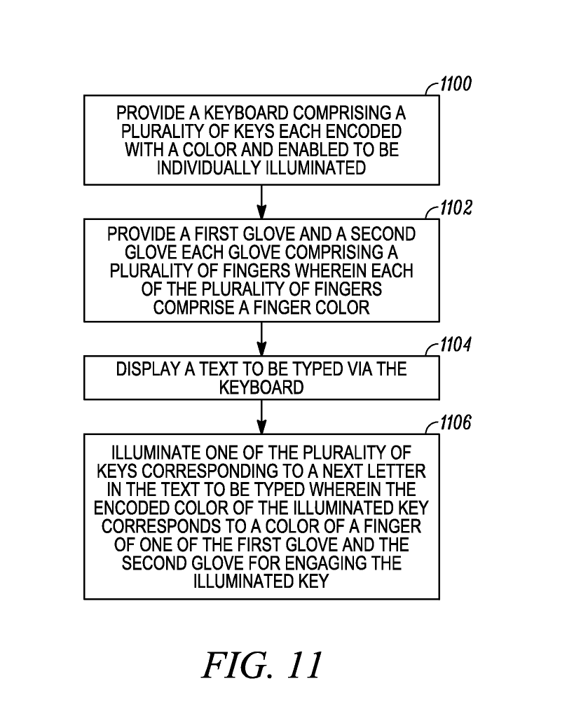

With reference to FIG. 11, there is illustrated a flow chart according to an exemplary and non-limiting embodiment. At step 1100, a keyboard comprising a plurality of keys each encoded with a color and enabled to be individually illuminated is provided. At step 1102, a first glove and a second glove each glove comprising a plurality of fingers wherein each of the plurality of fingers comprise a finger color are provided. At step 1104, a text to be typed via the keyboard is displayed. At step 1106, one of the plurality of keys corresponding to a next letter in the text to be typed is illuminated wherein the encoded color of the illuminated key corresponds to a color of a finger of one of the first glove and the second glove for engaging the illuminated key.

While the invention has been described in connection with certain preferred embodiments, other embodiments will be understood by one of ordinary skill in the art and are intended to fall within the scope of this disclosure, which is to be interpreted in the broadest sense allowable by law.

All documents referenced herein are hereby incorporated by reference.

What is claimed is:

1. A method comprising:
providing a keyboard comprising a plurality of keys each encoded with a color and enabled to be individually indicated;
providing a first glove and a second glove each glove comprising a plurality of fingers wherein each of the plurality of fingers comprise a finger color;
displaying a text to be typed via the keyboard; and
indicating one of the plurality of keys corresponding to a next letter in the text to be typed wherein the encoded color of the indicated key corresponds to a color of a finger of one of the first glove and the second glove for engaging the indicated key.

2. The method of claim 1 wherein at least one of the fingers of the first glove and the second is cut at a terminus to enable a finger of a user to extend beyond the terminus to engage one of the plurality of keys.

3. The method of claim 1 wherein said indicating comprises illuminating a first one of the plurality of the keys corresponding to a next letter in the text to be typed and second one of the plurality of the keys corresponding to a letter in the text to be typed after the next letter.

4. A method comprising:
displaying a virtual keyboard corresponding to a keyboard and comprising a plurality of keys each encoded with a color and enabled to be individually illuminated;
providing a first glove and a second glove each glove comprising a plurality of fingers wherein each of the plurality of fingers comprise a finger color;
displaying a text to be typed on the keyboard; and
illuminating one of the plurality of keys of the virtual keyboard corresponding to a next letter in the text to be typed wherein the encoded color of the illuminated key corresponds to a color of a finger of one of the first glove and the second glove for engaging the illuminated key on the keyboard.

5. The method of claim 4 wherein at least one of the fingers of the first glove and the second is cut at a terminus to enable a finger of a user to extend beyond the terminus to engage one of the plurality of keys.

6. The method of claim 4 wherein said indicating comprises indicating a first one of the plurality of the keys corresponding to a next letter in the text to be typed and second one of the plurality of the keys corresponding to a letter in the text to be typed after the next letter.

7. The method of claim 6 wherein the first one of the keys is indicated by a first circle encompassing the first key and wherein the second one of the keys is indicated by a second circle encompassing the second key.

8. The method of claim 7 wherein the first circle is larger than the second circle.

9. The method of claim 4 wherein the next letter to be typed is indicated on the virtual keyboard via a letterless mode.

10. The method of claim 4 wherein the virtual keyboard and the text are displayed on a computer screen.

11. The method of claim 10 wherein the computer screen comprises at least one control selected from the group consisting of a start over control, a choose text control, a mode control, a correction control and a timer control.

12. A computer readable medium containing program instructions wherein execution of the program instructions by one or more processors of a computer system causes the one or more processors to carry out the steps of:
displaying a virtual keyboard corresponding to a keyboard and comprising a plurality of keys each encoded with a color and enabled to be individually illuminated;
displaying a text to be typed on the keyboard; and
illuminating one of the plurality of keys of the virtual keyboard corresponding to a next letter in the text to be typed wherein the encoded color of the illuminated key corresponds to a color of a finger of a first glove and a second glove for engaging the illuminated key on the keyboard.

13. The computer readable medium of claim 12 wherein at least one of the fingers of the first glove and the second is cut at a terminus to enable a finger of a user to extend beyond the terminus to engage one of the plurality of keys.

14. The computer readable medium of claim 12 wherein said illuminating comprises illuminating a first one of the plurality of the keys corresponding to a next letter in the text to be typed and second one of the plurality of the keys corresponding to a letter in the text to be typed after the next letter.

15. The computer readable medium of claim 14 wherein the first one of the keys is illuminated by a first circle encompassing the first key and wherein the second one of the keys is illuminated by a second circle encompassing the second key.

16. The computer readable medium of claim 15 wherein the first circle is larger than the second circle.

17. The computer readable medium of claim 12 wherein the next letter to be typed is indicated on the virtual keyboard via a letterless mode.

18. The computer readable medium of claim 12 wherein the virtual keyboard and the text are displayed on a computer screen.

19. The computer readable medium of claim 18 wherein the computer screen comprises at least one control selected from the group consisting of a start over control, a choose text control, a mode control, a correction control and a timer control.
